(19) United States
(12) Patent Application Publication
(10) Pub. No.: US 2010/0256903 A1
(43) Pub. Date: Oct. 7, 2010

(54) VEHICLE TELEMATICS COMMUNICATION FOR GENERATING ROAD ROUTING INFORMATIION

(75) Inventor: Richard A. Johnson, Rochester Hills, MI (US)

Correspondence Address: General Motors Corporation;c/o REISING ETHINGTON P.C., P.O. BOX 4390, TROY, MI, 48099-4390, US

(73) Assignee: General Motors Corporation, Detroit, MI (US)

(21) Appl. No.: 12/416,697

(22) Filed: Apr. 1, 2009

(51) Int. Cl. G01C 21/34

(52) U.S. Cl. 701/209

(57) ABSTRACT

A system and method for generating road routing information and using that information in providing navigation services to drivers. The method involves collecting off-route data indicative of occurrences of vehicles deviating from a planned route. Clusters of related off-route occurrences can then be identified based on the off-route data, and for each of at least some of the clusters, a road condition (e.g., closed, new, shifted, congested) is determined based on attributes of the cluster. Thereafter, road routing information is generated based on the determined road condition. Various routing actions can then be carried out, such as updating map data so that the system can provide drivers with improved route guidance.

### TECHNICAL FIELD

The present invention relates generally to vehicle telematics and navigation systems and, more particularly, to techniques for analyzing route information received from vehicles via a telematics unit.

### BACKGROUND OF THE INVENTION

Vehicle navigation services enable a vehicle driver to request and receive navigation directions for a planned route between two or more geographic points. Occasionally, drivers deviate from a planned route that has been supplied to the vehicle—sometimes intentionally such as to make a stop or detour that was not part of the planned route, sometimes by mistake such as when a planned turn is missed, and sometimes as the result of external factors, such as because of a closed road or even a new road that provides a more efficient route to the next destination. Depending upon the type of vehicle navigation system installed (e.g., a vehicle with a GPS system versus one without), deviations from a planned route might generate re-route requests wherein the vehicle operator or the vehicle automatically itself requests a re-routing to the next destination following the occurrence of a deviation from the planned route. These re-route requests can be transmitted back to a call center (telematics service center) or other central facility. In some systems, a calculated re-route can be carried out at the vehicle by its navigation system itself; in other systems, the call center re-calculates and downloads a revised planned route to the vehicle.

### SUMMARY OF THE INVENTION

According to an aspect of the invention, there is provided a method of generating routing information for use in providing navigation services to drivers, comprising the steps of (a) receiving off-route data for different vehicles at a central facility, wherein the off-route data for each of the vehicles represents an occurrence of the vehicle deviating from a planned route being followed by the vehicle; (b) identifying clusters of related off-route occurrences; and (c) for each of at least some of the clusters, carrying out the following steps: (c1) determining a road condition based on the cluster; and (c2) generating road routing information based on the determined road condition.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is a flowchart depicting one embodiment of a method of generating road routing information via a telematics unit;

FIG. 3 is a geographic map showing a cluster of re-route requests indicative of a new road; and

FIG. 4 is a geographic map showing a cluster of re-route requests indicative of a closed road.

### DETAILED DESCRIPTION OF THE PREFERRED EMBODIMENT(S)

The system and methods described below are directed to different embodiments of an approach for generating road routing information for use in providing navigation services to drivers. The disclosed methods enable a telematics central facility to collect off-route data for different vehicles, identify clusters of related off-route occurrences, and for each of at least some of the clusters, to then determine a road condition based on the cluster and generate road routing information based on the determined road condition. The road routing information can be used to carry out a routing action, such as updating map data to reflect the road condition.

### Communications System—

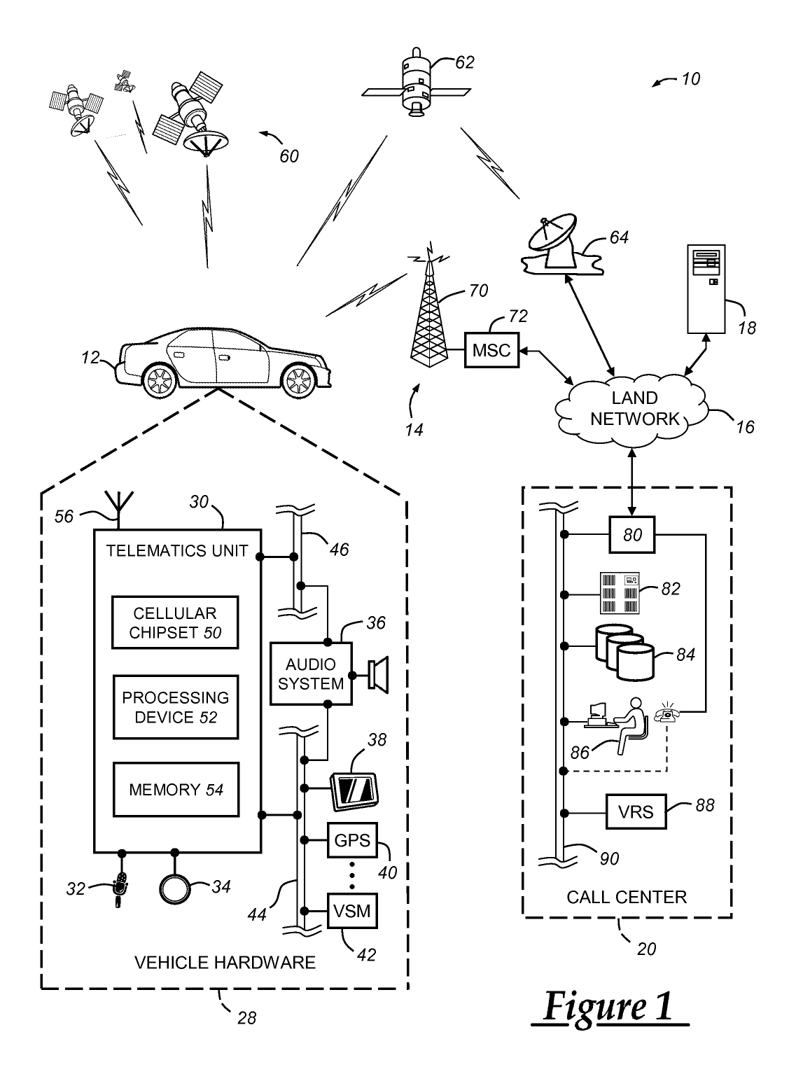

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live adviser or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisers 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live adviser phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live adviser 86, it will be appreciated that the call center can instead utilize VRS 88 as an automated adviser or, a combination of VRS 88 and the live adviser 86 can be used.

### Method—

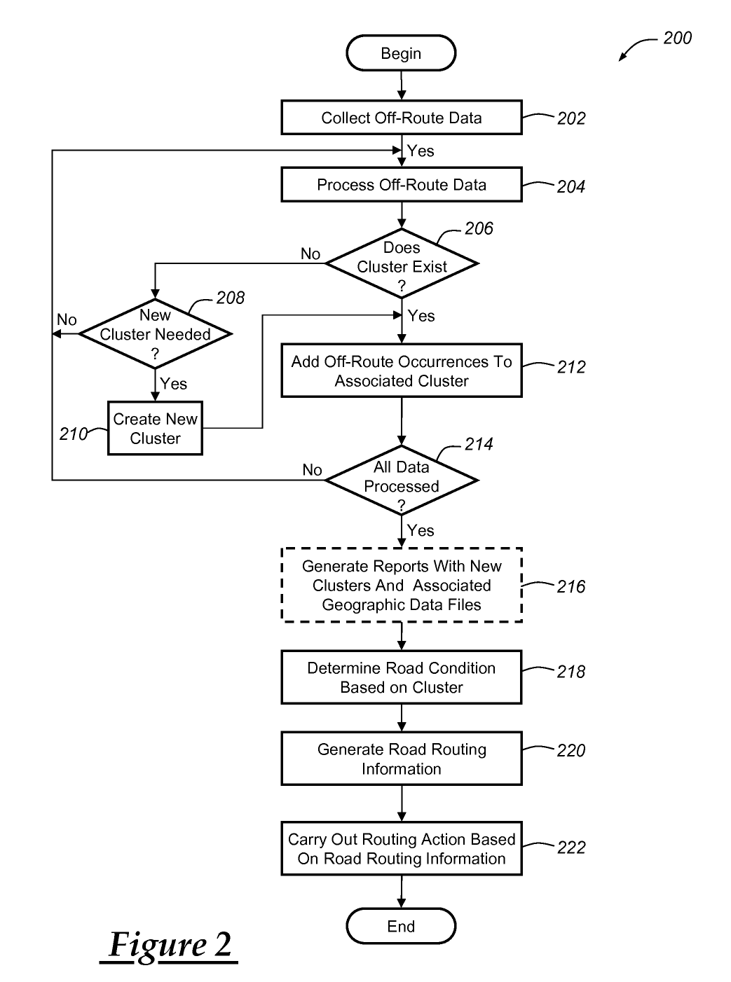

Turning now to FIG. 2, there is shown a method 200 for generating and using road routing information. The method starts at step 202 and begins by collecting off-route data. In one embodiment, the off-route data comes in the form of a re-route request to the call center 20 that can be triggered by a vehicle occupant or automatically from the vehicle when a deviation from a planned route occurs. In another embodiment, the off-route data can be a notification of a deviation that was re-routed automatically by the on-board GPS system 40, with the off-route data being uploaded to the call center 20 at an appropriate time for the purpose of carrying out method 200. Thus, this method can be carried out as an adjunct to other navigation services such as those that involve receiving a request for navigation instructions from a vehicle occupant, generating the planned route, and presenting the planned route to the occupant, such as via a display screen and/or in-vehicle speakers. Depending upon the particular vehicle navigation system involved, the planned route can generated on-board the vehicle or remotely at the call center 20. However done, the off-route data is provided to the call center 20 in response to the occurrence of the vehicle deviating from the planned route. Once received, the off-route data can be stored in database 84 for later processing or each individual item of off-route data can be processed as it is received. Preferably, the off-route data includes vehicle data necessary to determine both its location and heading. Location information can be, for example, GPS coordinates, whereas, heading information can be, for example, a compass heading reading or differential GPS coordinates used to indicate a direction of travel. Other useful vehicle data such as speed and time and date can be included as well. Various other types of suitable off-route data and methods of collecting that data will be apparent to those skilled in the art.

At step 204 the off-route data is processed. Depending on the approach for collecting the off-route data, it may or may not be indicative of the actual location where vehicle 12 has gone off-route. Therefore, if necessary or desired, method 200 processes off-route data by determining the actual off-route location. In one embodiment, the actual off-route location is determined based on the location where the re-route directions have been requested. For instance, the actual location can be determined by projecting backwards from the re-route request location along the traveled road to a distance computed by multiplying the speed of the vehicle times the time it takes for the re-route request to be generated. In another embodiment, method 200 simply uses the location where a re-route was requested.

The processing of the off-route data to assign it to individual clusters is shown at blocks 206-214. This process can be done iteratively for the off-route data from each of a plurality of different particular vehicles. At step 206, it is first determined if a cluster exists that corresponds to the individual item of off-route data being processed. A cluster can broadly be considered as a group of off-route data for individual vehicles that have deviated from their planned route due to a common road condition (e.g., closed road, new road, shifted road, etc.), and this can be determined in various ways such as by determining that the vehicles are at a similar geographic location when the off-route condition occurs. In some instances, the off-route data being processed might not correspond to a road condition, in which case the data can be saved, further processed, or discarded. In other cases, the off-route data for a particular vehicle results from a road condition, for which there may or may not already be a cluster that has been identified. Thus, at step 206, the off-route data is examined to determine whether it corresponds to an existing cluster that has already been identified. If so, the process moves to block 212 where the off-route data is added to or otherwise associated with that existing cluster. The cluster information can be stored in the database 84 or elsewhere.

To determine if the off-route data for a particular vehicle corresponds to a cluster, it can be compared to one or more established requirements for that cluster. These requirements can vary cluster to cluster, if desired. In one embodiment, a cluster can be defined as a set of off-route occurrences for which the associated vehicles have a location and heading that each meet a pre-established requirement. For example, the pre-established requirement for the location can be that each of the vehicles is within a preselected maximum distance (e.g., about 250 meters) of the other vehicles when the off-route condition occurred. For heading, the pre-established requirement can be that a determined direction of travel for each of the vehicles is within a preselected angle (e.g., within ±20 degrees) of all of the other vehicles. In another embodiment, the cluster can require not only the location and heading criteria noted above, but also a third condition that the vehicles are lined up along the heading. This can be determined in various ways, such as by only including off-route data points in the cluster for which no more than a 20 degree angle is formed between (1) a line going through any two of the off-route locations (a) meeting the two (location and heading) criteria above and (b) that are a certain minimum distance (e.g., 50 meters) apart and (2) each of the headings for the two off-route data points.

There are various ways to computationally find clusters using the criteria identified above. For example, every location representing an off-route occurrence can be compared to every other location for the three conditions (location, heading, and lining-up) noted above. When two off-route data points meet whatever cluster requirements are used, they are identified as belonging to the same cluster. In some embodiments, in order for subsequent off-route data to be associated with the cluster, that subsequent off-route data must meet the cluster requirements with every other off-route data point already in the cluster. The actual processing of the off-route data to determine and associate the data with clusters can be carried out in various ways that will be apparent to those skilled in the art. For example, in one approach, the off-route data is first ordered according to location based on their latitude only. Then, a location distance test (e.g., the 250 meters) is used based on latitude only (e.g., by assuming that the longitudes are the same). If two off-route locations pass this threshold latitude distance test, then one or more of the other criteria noted above (heading, lining up) can be applied. However, if the two points do not pass this threshold distance test, then it is assumed that all other off-route data positioned beyond this point in the ordered list will also not pass this threshold distance test and so for those points the additional tests (comparisons) need not be made. It should be appreciated by a skilled person in the art that other techniques can be used. For instance, the off-route location longitudes can be initially compared while ignoring the latitudes, or the actual separation distances can be calculated.

If an identified cluster does not yet exist, then step 208 is used to determine if a new cluster is needed. In one embodiment, this is done by determining whether there are a selected minimum number of vehicles having off-route data that indicate that their associated vehicle has a location and heading that each meet the pre-established requirement relative to each other; for example, that there are at least ten vehicles that went off-route within 250 meters of each other and along a heading that is within twenty degrees of each other. The selected minimum number can be chosen as desired, and can be more or less than ten, such as fifty, one hundred, or more. Where the minimum number of off-route occurrences does not yet exist in the iterative processing of steps 204-214, then the current off-route data can be stored for future processing, so that the process does not create a new cluster, but instead loops back to step 204 to process the next item of off-route data. However, if the minimum number of off-route occurrences has been met, then the process moves to step 210 where a new cluster is created.

Those skilled in the art will appreciate that the establishment of clusters can be handled in various other ways as well. For example, each piece of off-route data that does not correspond to an existing cluster can be used to create a new cluster and, after all processing is done, small clusters (e.g., those having less than a selected minimum number) can be discarded or ignored as not being sufficiently indicative of a road condition.

Once a new cluster is created, the process then moves to block 212 where the off-route data currently being processed is assigned to that new cluster. This can also include assigning any corresponding previously-processed and stored off-route data to that new cluster. In one embodiment, database 84 stores the off-route occurrences and their associated clusters. Afterward, method 200 continues with step 214 where it is determined whether all off-route data has been processed. If not, the process loops back to step 204 where processing begins for the next individual item of off-route data. In one embodiment, method 200 utilizes a first in first out (FIFO) technique to process the data. In another embodiment method 200 utilizes a last in first out (LIFO) technique to process the data. Skilled artisans will appreciate that a variety of techniques and models could be used for processing this information.

Once all off-route data has been processed the method moves to step 216 which in the method 200 is an optional step used to generate reports of new clusters and associated geographic data files. These reports may provide statistical data, analysis, data mining, social statistics, geographic information system, etc. In one embodiment, the report provides the list and number of off-route occurrences in a cluster and its associated keyhole markup language (KML) files which display geographic data in a browser. These are only few of several examples of what can be reported.

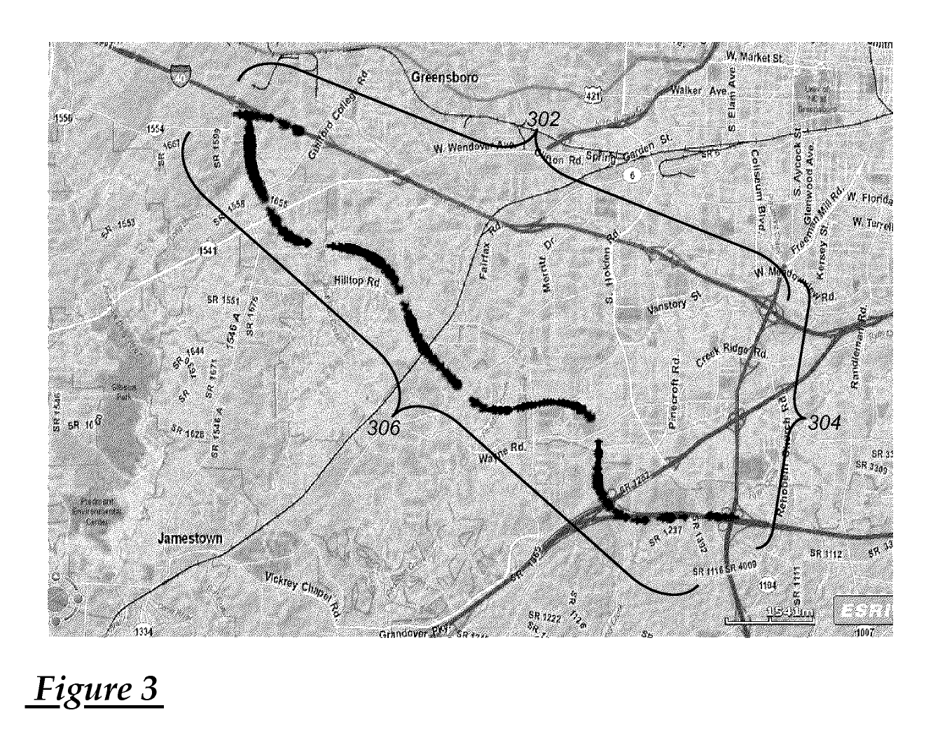

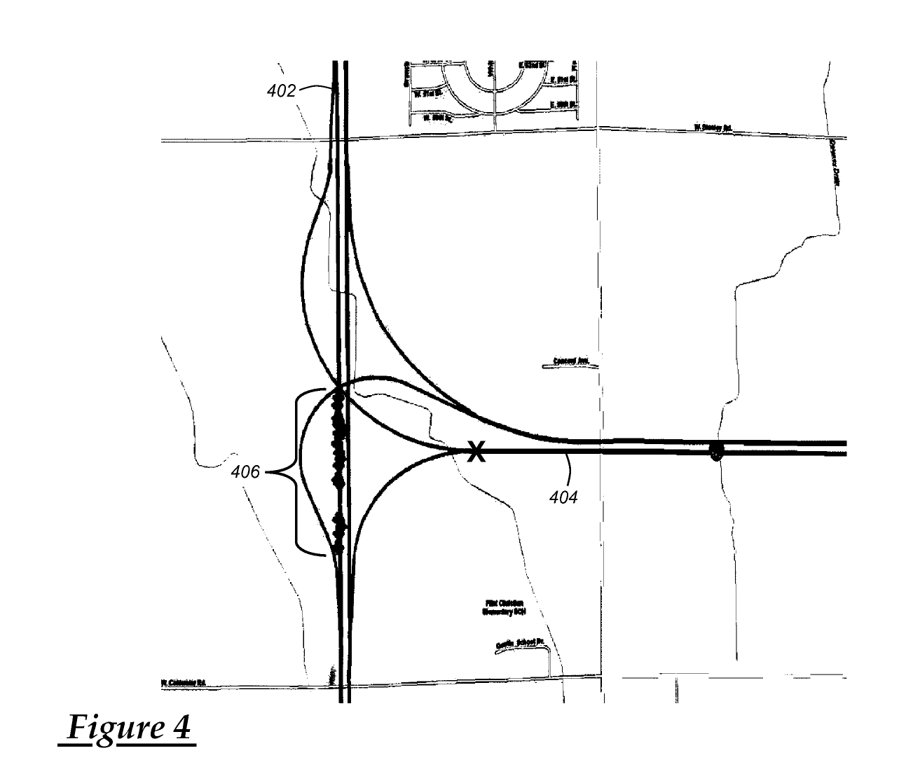

Step 218 determines road condition based on the cluster; that is, what is the cause of the clustered off-route occurrences. Possible road conditions includes new, moved, closed, and congested roads. In one embodiment, a new and/or moved road is identified by determining the distance and heading of each re-route occurrence in a cluster to the distance and heading of the nearest road segment in a map database. If the distance and/or the heading are greater than some threshold then the road is identified as new and/or moved road. FIG. 3 provides an example of a new road 306. The cluster 306 of off-route data points identifies a new road that drivers are using instead of the planned route using roads 302 and 304. In another embodiment, a closed road can be identified if re-route occurrences have a definite start time (e.g., specific date, specific day of the week, specific time of the day, etc.) and the majority if not all of the telematics service users request a re-route. FIG. 4 provides an example of a closed road 404, which can occur because of road construction. In this example, an exit at point 402 from one highway is closed, thereby preventing southbound drivers from taking the exit ramp onto a second, eastbound highway 404 that is under repair. Cluster 406 of re-route requests is indicative of this road closure and that data, along with, for example, a fixed start date to the off-route data (e.g., re-route requests began suddenly one day) can be used to surmise the closed road condition. Furthermore, the actual starting location 402 of the road closure can be determined from the off-route data, even though the location of the off-route data is different than that point. This determination can be done based on vehicle speed and heading, as mentioned above.

Other types of road conditions can be detected as well. For example, a detour can be identified where re-route occurrences have a definite start time (e.g., specific date, specific day of the week, specific time of the day, etc.) and are in the vicinity of a known closed road. Also, a congested road condition can be identified when re-route requests have been generated month after month and possibly year after year, but not all navigation services users generate off-route occurrences. Furthermore, for congested roads the ratio of users generating off-route condition to users not generating off-route condition does not vary greatly for statistically significant sample sizes. This can therefore be used as one of the factors used to determine that a cluster corresponds to a congested road condition. The clusters can also be associated with other road conditions. For instance, it should be appreciated by a person skilled in the art that clusters can exist because of tunnels and express lanes (causing determined vehicle position to be shifted from the planned route), as well as expressway work (also causing vehicle position to be shifted from the planned route, e.g., northbound traffic shifted onto the southbound lanes during road construction). Suitable tests for analyzing the clusters to determine these and other road conditions will be apparent to those skilled in the art.

Once the road condition for a cluster is determined, the process moves to step 220 to generate road routing information. Generally, the road routing information is any information indicative of the determined road condition. For example, road closure information can be generated in response to determining a closed road condition. For a new road or inaccurately mapped road, new road information can be generated. For a congested road condition, traffic data including expected vehicle speeds at different times of day can be generated. Other useful road routing information can be generated as well.

Finally, in step 222 a routing action is carried out based on road routing information. Various different routing actions can be performed using the road routing information. For instance, a road closure notification can be added to an electronic roads closure feed. In addition, the route guidance provided by the call center 20 or vehicle navigation system can be updated to take into account a road closure, road congestion or other road condition. Thus, for example, a revised or new planned route can provide a detour around the closed road. Or, the navigation guidance can provide a route that includes a new road such as the one described on FIG. 3. Also, the road routing information can be added to a map or otherwise used to update map data. Routing and/or navigation behavior can be adjusted according to the road routing information. In one embodiment, the road routing information is used to generate routing directions that avoid congested roads during rush hours. In another embodiment, routing directions are generated with both highways and no highways options. For example, the user has the option to follow either a highway option or a scenic road option.

Thus, the method 200 enables off-route data to be processed into useful navigation guidance information that can be used to provide improved planned routes for drivers. For route planning performed at the call center 20 or other central facility, the map data and other route guidance information at the central facility can be updated based on the road routing information generated by the cluster analysis. And, for route planning performed in the vehicle, such as by use of GPS module 40, updated map and traffic data resulting from the cluster analysis can be downloaded to the vehicle as part of a navigation system update.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of generating road routing information for use in providing navigation services to drivers, comprising the steps of:
(a) collecting off-route data for different vehicles at a central facility, wherein the off-route data for each of the vehicles represents an occurrence of the vehicle deviating from a planned route being followed by the vehicle;
(b) identifying clusters of related off-route occurrences based on the off-route data; and
(c) for each of at least some of the clusters, carrying out the following steps:
(c1) determining a road condition based on the cluster; and
(c2) generating road routing information based on the determined road condition.

2. The method of claim 1, wherein, for each of at least some of the vehicles, the method further comprises, prior to step (a) the steps of receiving a request for navigation instructions, generating the planned route, and sending the planned route to the vehicle, and wherein step (a) further comprises receiving a re-route request in response to the occurrence of the vehicle deviating from the planned route.

3. The method of claim 1, wherein step (a) further comprises receiving re-route requests from vehicles.

4. The method of claim 1, wherein step (b) further comprises identifying a group of off-route occurrences for which the associated vehicles have a location and heading that each meet a pre-established requirement.

5. The method of claim 4, wherein the pre-established requirement for the location is that each of the vehicles is within a preselected maximum distance of the other vehicles when the off-route condition occurred.

6. The method of claim 5, wherein the preselected maximum distance is no more than 250 meters.

7. The method of claim 4, wherein the pre-established requirement for the heading is that a determined direction of travel for each of the vehicles is within a preselected angle of the other vehicles.

8. The method of claim 7, wherein the preselected angle is no more than 20 degrees.

9. The method of claim 4, wherein step (b) further comprises identifying a group of off-route occurrences for which the associated vehicles are lined up along the heading.

10. The method of claim 1, wherein step (b) further comprises the steps of:
determining if the off-route data corresponds to an existing cluster and, if not, assembling similar off-route occurrences into a new cluster; and
creating reports with new clusters and associated geographic data files.

11. The method of claim 1, wherein step (c2) further comprises generating road closure information based on the determined road condition.

12. The method of claim 1, further comprising the step (c3) of carrying out a routing action based on the road routing information.

13. The method of claim 12, wherein the routing action comprises updating map data using the road routing information.

14. The method of claim 12, wherein the routing action comprises changing navigation guidance.

15. The method of claim 14, wherein changing navigation guidance further comprises providing a route that includes a new road.

16. The method of claim 12, wherein the routing action comprises changing routing behavior.

17. The method of claim 12, wherein the routing action comprises changing map data to reflect shifted roads based on the road routing information.

18. A method of generating and using road routing information for use in connection with navigation services provided to drivers, comprising the steps of:
(a) collecting off-route data for different vehicles at a central facility, wherein the off-route data for each of the vehicles represents an occurrence of the vehicle deviating from a planned route being followed by the vehicle;
(b) identifying clusters of related off-route occurrences by processing the off-route data for each of at least some of the vehicles using the following steps (b1)-(b3):
(b1) associating the off-route data for a particular vehicle with an existing cluster if the off-route data for that particular vehicle indicates a location and heading that each meet a pre-established requirement relative to other off-route data in that existing cluster;
(b2) if the off-route data for that particular vehicle indicates a location and heading that do not meet the pre-established requirements for an existing cluster, then determining if there are a selected minimum number of vehicles having off-route data that indicate that their associated vehicle has a location and heading that each meet the pre-established requirement relative to each other; and
(b3) identifying a new cluster where the desired minimum number of vehicles is determined to exist; and
(c) for each of at least some of the identified clusters, carrying out the following steps (c1)-(c3):
(c1) determining road condition based on cluster;
(c2) generating road routing information based on the road condition; and
(c3) carrying out routing action based on road routing information.

19. The method of claim 18, wherein the pre-established requirement for location is that all off-route data associated with the cluster indicate a vehicle location that is within 250 meters of each other.

20. The method of claim 18, wherein the pre-established requirement for heading is that all off-route data associated with the cluster indicate a direction of travel that is within a 20° angle of each other.
